(19) United States
(12) Patent Application Publication
(10) Pub. No.: US 2023/0402754 A1
(43) Pub. Date: Dec. 14, 2023

(54) ANTENNA DEVICE, TERMINATOR, AND TERMINAL DEVICE

(71) Applicant: Sony Group Corporation, Tokyo (JP)

(72) Inventor: Takahiro TAKEDA, Kanagawa (JP)

(73) Assignee: Sony Group Corporation, Tokyo (JP)

(21) Appl. No.: 18/035,693

(22) PCT Filed: Nov. 10, 2021
(86) PCT No.: PCT/JP2021/041267

§ 371 Date: May 5, 2023

(30) Foreign Application Priority Data
Dec. 17, 2020 (JP) 2020-209014

(51) Int. Cl. H01Q 5/49; H01Q 1/46; H01Q 13/08; H01Q 1/22

(52) U.S. Cl. CPC H01Q 5/49; H01Q 1/46; H01Q 13/08; H01Q 1/2208

(57) ABSTRACT

An antenna device (1) includes one or a plurality of feeding antennas (3) provided on a main surface (2a) of a substrate (2), a parasitic antenna (4) provided on the substrate (2), and a terminator (5) provided on the substrate (2) and connected to the parasitic antenna (4). The terminator (5) includes an SIW (52) that is a waveguide extending in the substrate (2).

### FIELD

The present disclosure relates to an antenna device, a terminator, and a terminal device.

### BACKGROUND

In order to reduce variations in radiation characteristics of a plurality of feeding antennas, an antenna device including a terminated parasitic antenna (dummy antenna) has been known. For example, Patent Literature 1 discloses a method of terminating a parasitic antenna with a termination antenna for a polarized wave orthogonal to a polarized wave of a feeding antenna.

### CITATION LIST

### Patent Literature

Patent Literature 1: JP 2018-74240 A

### SUMMARY

### Technical Problem

In the conventional termination antenna explained in Patent Literature 1, since a band that can be effectively terminated by the parasitic antenna is narrow, it is difficult to suppress the variations in the radiation characteristics of the plurality of feeding antennas over a wide band.

One aspect of the present disclosure provides an antenna device, a terminator, and a terminal device capable of suppressing variations in radiation characteristics of a plurality of feeding antennas over a wide band.

### Solution to Problem

An antenna device according to one aspect of the present disclosure includes: one or a plurality of feeding antennas provided on a main surface of a substrate; a parasitic antenna provided on the main surface of the substrate; and a terminator provided on the substrate and connected to the parasitic antenna, wherein the terminator includes an SIW that is a waveguide extending in the substrate.

A terminator according to one aspect of the present disclosure includes an SIW that is a waveguide extending in a substrate, wherein the substrate is a multilayer substrate, and the SIW includes: a first SIW extending in a first layer; and a second SIW extending in a second layer.

A terminator according to one aspect of the present disclosure includes: an SIW that is a waveguide extending in a substrate; and a microstrip line connected to the SIW, wherein the SIW has a constant width.

A terminal device according to one aspect of the present disclosure includes a transmission and reception unit, a control unit, and an antenna device, wherein the terminal device is a communication device, the antenna device includes: one or a plurality of feeding antennas provided on a main surface of a substrate; a parasitic antenna provided on the main surface of the substrate; and a terminator provided on the substrate and connected to the parasitic antenna, and the terminator includes an SIW that is a waveguide extending in the substrate.

A terminal device according to one aspect of the present disclosure includes a transmission unit, a reception unit, a control unit, and an antenna device, wherein the terminal device is a radar device, the antenna device includes: one or a plurality of feeding antennas provided on a main surface of a substrate; a parasitic antenna provided on the main surface of the substrate; and a terminator provided on the substrate and connected to the parasitic antenna, and the terminator includes an SIW that is a waveguide extending in the substrate.

### BRIEF DESCRIPTION OF DRAWINGS

FIG. 1 is a diagram illustrating an example of a schematic configuration of an antenna device according to an embodiment.

FIG. 2 is a diagram illustrating an example of a schematic configuration of a terminator.

FIG. 3 is a diagram illustrating an example of a schematic configuration of the terminator.

FIG. 4 is a diagram illustrating an example of a schematic configuration of the terminator.

FIG. 5 is a diagram illustrating an example of a simulation result of an SIW.

FIG. 6 is a diagram illustrating an example of a simulation result of the SIW.

FIG. 7 is a diagram illustrating an example of radiation characteristics of a plurality of feeding antennas.

FIG. 8 is a diagram illustrating an example of radiation characteristics of the plurality of feeding antennas.

FIG. 9 is a diagram illustrating an example of radiation characteristics of the plurality of feeding antennas.

FIG. 10 is a diagram illustrating an example of radiation characteristics of the plurality of feeding antennas.

FIG. 11 is a diagram illustrating an example of radiation characteristics of the plurality of feeding antennas.

FIG. 12 is a diagram illustrating an example of a schematic configuration of an antenna device according to a comparative example.

FIG. 13 is a diagram illustrating an example of radiation characteristics of a plurality of feeding antennas.

FIG. 14 is a diagram illustrating an example of radiation characteristics of the plurality of feeding antennas.

FIG. 15 is a diagram illustrating an example of radiation characteristics of the plurality of feeding antennas.

FIG. 16 is a diagram illustrating an example of radiation characteristics of the plurality of feeding antennas.

FIG. 17 is a diagram illustrating an example of radiation characteristics of the plurality of feeding antennas.

FIG. 18 is a diagram illustrating an example of a schematic configuration of an antenna device according to a comparative example.

FIG. 19 is a diagram illustrating an example of radiation characteristics of a plurality of feeding antennas.

FIG. 20 is a diagram illustrating an example of radiation characteristics of the plurality of feeding antennas.

FIG. 21 is a diagram illustrating an example of radiation characteristics of the plurality of feeding antennas.

FIG. 22 is a diagram illustrating an example of radiation characteristics of the plurality of feeding antennas.

FIG. 23 is a diagram illustrating an example of radiation characteristics of the plurality of feeding antennas.

FIG. 24 is a diagram illustrating an example of a schematic configuration of an antenna device according to a comparative example.

FIG. 25 is a diagram illustrating an example of a simulation result of a termination antenna.

FIG. 26 is a diagram illustrating an example of radiation characteristics of a plurality of feeding antennas.

FIG. 27 is a diagram illustrating an example of radiation characteristics of the plurality of feeding antennas.

FIG. 28 is a diagram illustrating an example of radiation characteristics of the plurality of feeding antennas.

FIG. 29 is a diagram illustrating an example of radiation characteristics of the plurality of feeding antennas.

FIG. 30 is a diagram illustrating an example of radiation characteristics of the plurality of feeding antennas.

FIG. 31 is a diagram illustrating a modification.

FIG. 32 is a diagram illustrating a modification.

FIG. 33 is a diagram illustrating a modification.

FIG. 34 is a diagram illustrating a modification.

FIG. 35 is a diagram illustrating a modification.

FIG. 36 is a diagram illustrating a modification.

FIG. 37 is a diagram illustrating a modification.

FIG. 38 is a diagram illustrating a modification.

FIG. 39 is a diagram illustrating a modification.

FIG. 40 is a diagram illustrating a modification.

FIG. 41 is a diagram illustrating a modification.

FIG. 42 is a diagram illustrating a modification.

FIG. 43 is a diagram illustrating a modification.

FIG. 44 is a diagram illustrating a modification.

FIG. 45 is a diagram illustrating an example of a schematic configuration of a radar device.

FIG. 46 is a diagram illustrating an example of a schematic configuration of a communication device.

### DESCRIPTION OF EMBODIMENT

An embodiment of the present disclosure is explained in detail below with reference to the drawings. Note that, in the embodiment explained below, redundant explanation is omitted by denoting the same elements with the same reference numerals and signs.

The present disclosure is explained according to order of items described below.
1. Embodiment
2. Modification
3. Application Examples
3.1 Application example to a radar device
3.2 Application example to a communication device
4. Effects

### 1. EMBODIMENT

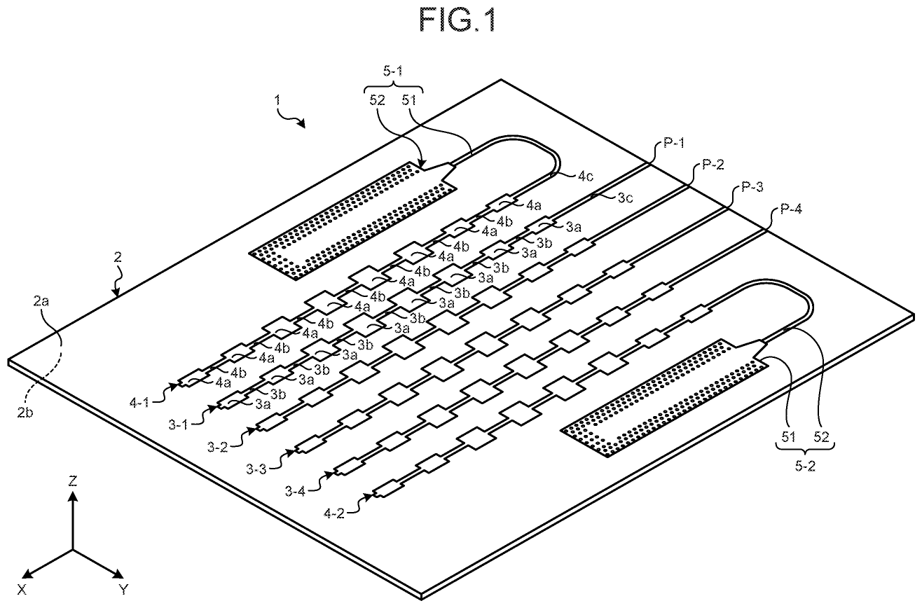

FIG. 1 is a diagram illustrating an example of a schematic configuration of an antenna device according to an embodiment. The antenna device 1 includes a substrate 2, feeding antennas 3, parasitic antennas 4, and terminators 5. In the figure, an XYZ coordinate system is illustrated. The X-axis direction and the Y-axis direction are equivalent to the plane direction of the substrate 2. The Z-axis direction is equivalent to the thickness direction of the substrate 2.

Components of the antenna device 1 are provided on the substrate 2. Examples of the components are the feeding antennas 3, the parasitic antennas 4, and the terminators 5, which are configured by metal patterns, vias, and the like formed on the substrate 2. The surface of the substrate 2 on the Z-axis positive direction side is referred to as main surface 2a and illustrated. The surface of the substrate 2 on the Z negative direction side is referred to as rear surface 2b and illustrated. The substrate 2 may be a multilayer substrate, which is explained again below.

The feeding antennas 3 are (for example, a plurality of) feeding antennas provided (for example, arranged side by side) on the main surface 2a of the substrate 2. The feeding antennas 3 are referred to as feeding antenna 3-1, feeding antenna 3-2, feeding antenna 3-3, and feeding antenna 3-4 and illustrated to be able to be distinguished from one another. In this example, the feeding antenna 3-1, the feeding antenna 3-2, the feeding antenna 3-3, and the feeding antenna 3-4 are arranged in this order at equal intervals in the Y axis positive direction.

The feeding antenna 3 includes a plurality of patches 3a, a plurality of microstrip lines 3b, and a microstrip line 3c.

The patches 3a are provided side by side at intervals in the X-axis direction. At least a part of the patches 3a may have shapes different from one another. In this example, the patches 3a have a rectangular shape and the width (length in the Y-axis direction) of the patches 3a increases such that the area of the patches 3a increases toward the centers of the feeding antennas 3.

The microstrip lines 3b are connected among the patches 3a adjacent to one another. The line width of the microstrip lines 3b may be smaller than the width of the patches 3a.

The microstrip line 3c is connected to a port P. In this example, the microstrip line 3c is connected between the patch 3a located at the farthest end of the feeding antenna 3 and the port P. Ports P connected to the feeding antenna 3-1, the feeding antenna 3-2, the feeding antenna 3-3, and the feeding antenna 3-4 are referred to as port P-1, port P-2, port P-3, and port P-4 such that the ports P can be distinguished from one another.

The port P-1, the port P-2, the port P-3, and the port P-4 may be feeding points. The feeding antenna 3-1, the feeding antenna 3-2, the feeding antenna 3-3, and the feeding antenna 3-4, which are connected to different feeding points, are used as, for example, multiple input multiple output (MIMO) antennas.

The parasitic antennas 4 are provided on the main surface 2a of the substrate 2, for example, according to the arrangement of the plurality of feeding antennas 3. In this example, the parasitic antennas 4 are provided further on the outer side of the feeding antenna 3-1 and the feeding antenna 3-4 on the outermost side among the plurality of feeding antennas 3. The parasitic antennas 4 are dummy antennas and are different from the feeding antennas 3 in that the parasitic antennas 4 are connected to the terminators 5 without being connected to the feeding points. The parasitic antennas 4 may have the same configuration as the feeding antennas 3 except for a configuration concerning the connection of the terminators 5.

FIG. 1 illustrates, as the parasitic antennas 4, a parasitic antenna 4-1 and a parasitic antenna 4-2. The parasitic antenna 4-1 and the parasitic antenna 4-2 are a pair of parasitic antennas provided to sandwich the plurality of feeding antennas 3. The parasitic antenna 4-1 is disposed on the opposite side of the feeding antenna 3-2 across the feeding antenna 3-1. The parasitic antenna 4-2 is disposed on the opposite side of the feeding antenna 3-3 across the feeding antenna 3-4. The parasitic antenna 4-1, the feeding antenna 3-1, the feeding antenna 3-2, the feeding antenna 3-3, the feeding antenna 3-4, and the parasitic antenna 4-2 are disposed in this order at equal intervals in the Y-axis positive direction.

Technical significance of the parasitic antennas 4 is explained. When the parasitic antennas 4 are absent, an antenna layout becomes asymmetric. Specifically, while different antennas are disposed on both sides in each of the feeding antenna 3-2 and the feeding antenna 3-3, different antennas are arranged only on one side in the feeding antenna 3-1 and the feeding antenna 3-4. This asymmetric antenna layout affects the balance of coupling between the antennas and causes variations in the radiation characteristics of the plurality of feeding antennas 3.

In contrast, since the parasitic antennas 4 are present, other antennas are disposed on both sides in all of the plurality of feeding antennas 3. Since a symmetric antenna layout is obtained, variations in the radiation characteristics of the plurality of feeding antennas 3 can be suppressed. However, in order to enhance this suppression effect, it is necessary to terminate the parasitic antennas 4. In the antenna device 1 according to the embodiment, the terminators 5 explained below are used for the termination of the parasitic antennas 4.

The terminators 5 are provided on the substrate 2 and is connected to the corresponding parasitic antennas 4. The terminators 5 are referred to as terminator 5-1 and terminator 5-2 such that the terminators 5 can be distinguished from each other. The terminator 5-1 corresponds to the parasitic antenna 4-1. The terminator 5-2 corresponds to the parasitic antenna 4-2.

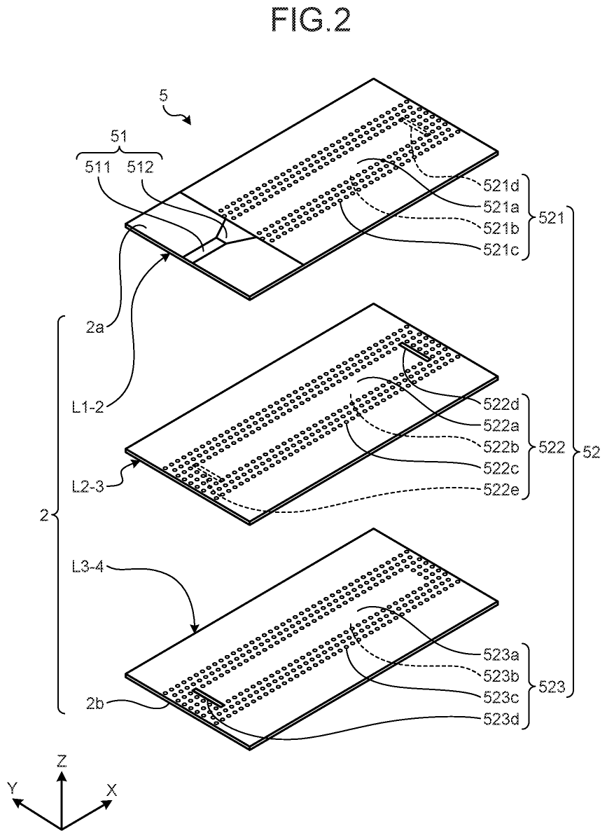

The terminators 5 include microstrip lines 51 and SIWs 52. The microstrip lines 51 are connected between the parasitic antennas 4 and the SIWs 52. The SIWs 52 are waveguides (SIWs: Substrate integrated waveguides) extending in the substrate 2. The width of the SIWs 52 may be different from the width of the microstrip lines 51. In this example, the width of the SIWs 52 is larger than the width of the microstrip lines 51. The terminators 5 including the microstrip lines 51 and the SIWs 52 is explained with reference to FIG. 2 to FIG. 4.

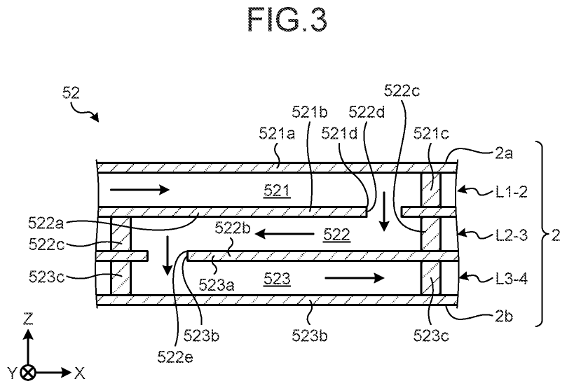

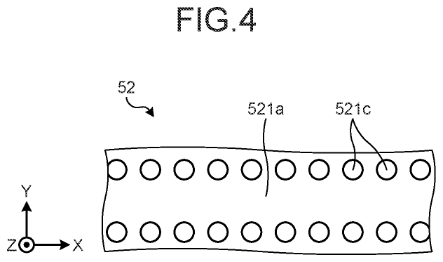

FIG. 2 to FIG. 4 are diagrams illustrating examples of schematic configurations of the terminator. In FIG. 2, an exploded perspective view of the terminator 5 is schematically illustrated. In FIG. 3, a partial sectional view of the terminator is schematically illustrated and a waveguide path is conceptually indicated by an arrow. In FIG. 4, a partial plan view of the terminator is schematically illustrated.

In this example, the substrate 2 is a multilayer substrate and includes a layer L1-2, a layer L2-3, and a layer L3-4 located in order from the main surface 2a of the substrate 2 toward the rear surface 2b (toward the Z-axis negative direction). The layer L1-2 is a first layer located on the uppermost side (the Z-axis positive direction side). The upper surface of the layer L1-2 is the main surface 2a of the substrate 2. The layer L2-3 and the layer L3-4 are located further on the rear surface 2b of the substrate 2 than the layer L1-2. Among the layers, the layer L2-3 is a second layer located between the layer L1-2 and the layer L3-4. The layer L3-4 is a third layer located on the lowermost side (the Z-axis negative direction side). The surface on the lower surface (the Z-axis negative direction side) of the layer L3-4 is the rear surface 2b of the substrate 2. All of the layers L1-2, L2-3 and L3-4 may have the same layer thickness.

The microstrip line 51 includes a first portion 511 and a second portion 512. The first portion 511 has, for example, the same width as a microstrip line 4c (FIG. 1) of the parasitic antenna 4 and is connected to the microstrip line 4c. The second portion 512 is connected between the first portion 511 and the SIW 52. The second portion 512 has a tapered shape. Specifically, the width of the second portion 512 changes in the tapered shape to fill the difference between the width of the first portion 511 and the width of the SIW 52 (to fill the difference in characteristic impedance). In this example, the width of the second portion 512 increases from the first portion 511 toward the SIW 52.

The SIW 52 includes a plurality of SIWs extending through layers in the substrate 2. In this example, the SIW 52 includes an SIW 521, an SIW 522, and an SIW 523.

The SIW 521 is connected to the second portion 512 of the microstrip line 51 and extends in the layer L1-2. In this example, the SIW 521 has constant width and extends straight in the X-axis positive direction. The SIW 521 includes an upper pattern 521a, a lower pattern 521b, vias 521c, and an opening 521d.

The upper pattern 521a and the lower pattern 521b define side surfaces extending in an XY plane direction among the side surfaces of the SIW 521. In this example, the upper pattern 521a is a part of a metal pattern formed on the surface on the upper side (the Z-axis positive direction side) of the layer L1-2, that is, on the main surface 2a of substrate 2. The lower pattern 521b is a part of a metal pattern formed on the surface on the lower side (the Z-axis negative direction side) of the layer L1-2.

The vias 521c define a side surface extending in the Z-axis direction among the side surfaces of the SIW 521. In this example, the vias 521c are a plurality of vias that connect the outer edge portion of the upper pattern 521a and the outer edge portion of the lower pattern 521b. The plurality of vias are formed along the outer edges of the upper pattern 521a and the lower pattern 521b (threefold in this example).

The opening 521d is located at the distal end portion (the end portion on the X-axis positive direction side) of the SIW 521 and connects the SIW 521 to the SIW 522 in series. In this example, the opening 521d is a slit formed in the lower pattern 521b. The opening 521d causes the layer L1-2 and the layer L2-3 to communicate in conjunction with an opening 522d explained below. The width (the length in the Y-axis direction) of the opening 521d may be the same as the width of the SIW 521.

The SIW 522 is connected to the SIW 521 and extends in the layer L2-3. In this example, the SIW 522 has a constant width and extends straight in the direction (X-axis negative direction) opposite to the extending direction of the SIW 521 (the X-axis positive direction). The length of the SIW 522 may be the same as the length of the SIW 521. The SIW 522 includes an upper pattern 522a, a lower pattern 522b, vias 522c, an opening 522d, and an opening 522e.

The upper pattern 522a and the lower pattern 522b define side surfaces extending in the XY plane direction among the side surfaces of the SIW 522. In this example, the upper pattern 522a is a part of a metal pattern formed on the upper surface of the layer L2-3. The lower pattern 522b is a part of a metal pattern formed on the lower surface of the layer L3-4.

The vias 522c define a side surface extending in the Z-axis direction among the side surfaces of the SIW 522. In this example, the vias 522c are a plurality of vias that connect the outer edge portion of the upper pattern 522a and the outer edge portion of the lower pattern 522b. The plurality of vias are formed along the outer edges of the upper pattern 522a and the lower pattern 522b (threefold in this example). The vias 522c may be formed integrally with the vias 521c.

The opening 522d is located at the proximal end portion (the end portion on the X-axis positive direction side) of the SIW 522 and connects the SIW 522 to the SIW 521 in series. In this example, the opening 522d is a slit formed in the upper pattern 522a. The opening 522d causes the layer L2-3 and the layer L1-2 to communicate in conjunction with the opening 521d. The width of the opening 521d may be the same as the width of the SIW 522.

The opening 522e is located at the distal end portion (the end portion on the X-axis negative direction side) of the SIW 522 and connects the SIW 522 to the SIW 523 in series. In this example, the opening 522e is a slit formed in lower pattern 522b. The opening 522e causes the layer L2-3 and the layer L3-4 to communicate in conjunction with an opening 523d explained below. The width of the opening 522e may be the same as the width of the SIW 522.

The SIW 523 is connected to the SIW 522 and extends in the layer L3-4. In this example, the SIW 523 has a constant width and extends straight in a direction (the X-axis positive direction) opposite to the extending direction of the SIW 522 (the X-axis negative direction). The length of the SIW 523 may be the same as the length of the SIW 522. The SIW 523 includes an upper pattern 532a, a lower pattern 532b, vias 532c, and an opening 523d.

The upper pattern 523a and the lower pattern 523b define side surfaces extending in the XY plane direction among the side surfaces of the SIW 523. In this example, the upper pattern 523a is a part of a metal pattern formed on the upper surface of the layer L3-4. The lower pattern 523b is a part of a metal pattern formed on the lower surface of the layer L3-4.

The vias 523c define a side surface extending in the Z-axis direction among the side surfaces of the SIW 523. In this example, the vias 523c are a plurality of vias that connect the outer edge portion of the upper pattern 523a and the outer edge portion of the lower pattern 523b. The plurality of vias are formed along the outer edges of the upper pattern 523a and the lower pattern 523b (threefold in this example). The vias 523c may be formed integrally with the vias 522c.

The length of the SIW 52 is equal to the total length of the SIW 521, the SIW 522, and the SIW 523 connected in series. In the example explained above, the SIW 521 and the SIW 523 extend in the same direction (the X-axis positive direction) and the SIW 522 extends in the opposite direction (the X-axis negative direction). In this case, the SIW 521, the SIW 522, and the SIW 523 overlap (at least partially overlap) (even in portions other than the openings) when the substrate 2 is viewed in a plan view (when viewed in the Z-axis direction). The degree of overlap increases as the lengths and the widths of the SIW 521, the SIW 522, and the SIW 523 are closer. When the SIW 521, the SIW 522, and the SIW 523 have the same length and the same width, the SIW 521, the SIW 522, and the SIW 523 completely overlap when the substrate 2 is viewed in the plan view.

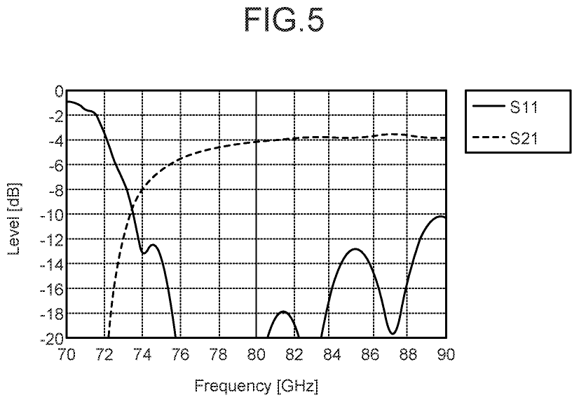

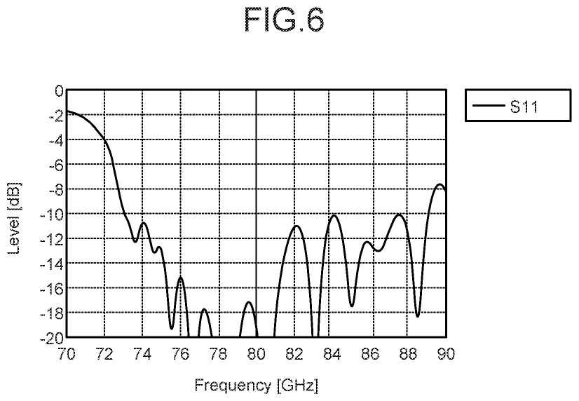

The SIW 52 explained above provides a large attenuation amount over a wide band. This is explained with reference to FIG. 5 and FIG. 6.

FIG. 5 is a diagram illustrating an example of a simulation result of an SIW. About some simulation conditions, a relative dielectric constant εᵣ of a substrate is 3.36, the thickness of the substrate is 78 μm, the width of the SIW is 1.15 mm, and the length of the SIW is 1 cm. The horizontal axis of a graph represents a frequency (GHz) and the vertical axis of the graph represents magnitudes (dB) S11 and S21.

The SIW has a cutoff frequency. The cutoff frequency is determined mainly by the dimensions (width and the like) of the SIW, the dielectric constant of a substrate material, and the like. In this example, the cutoff frequency is approximately 72 GHz. At a frequency higher than the cutoff frequency, an attenuation amount (a loss) increases as the frequency is closer to the cutoff frequency. However, there is still an attenuation amount at a frequency far from the cutoff frequency to a certain degree. In this example, even at a frequency of 77 GHz or more, an attenuation amount of approximately −4 dB is obtained over a wide band. This attenuation amount is considerably larger than, for example, an attenuation amount of a microstrip line (for example, approximately −1.3 dB/cm).

FIG. 6 illustrates an example of a simulation result of the SIW 52 of the terminator 5 in FIG. 2 to FIG. 4 explained above. The relative dielectric constant E r of the substrate 2 is 3.36, layer thicknesses (equivalent to the height of each of the SIW 521 to the SIW 523) are 78 μm, the width of each of the SIW 521 to the SIW 523 is 1.15 mm, and the length of each of the SIW 521 to the SIW 523 is 1 cm. The horizontal axis of the graph indicates the frequency (GHz) and the vertical axis of the graph indicates the level (dB) of the return loss.

As illustrated in FIG. 6, a return loss of −15 dB or less is obtained over a wide band having a frequency of 76 GHz to 81 GHz. Even at a frequency of 73 GHz to 89 GHz as well, a return loss of −10 dB or less can be obtained.

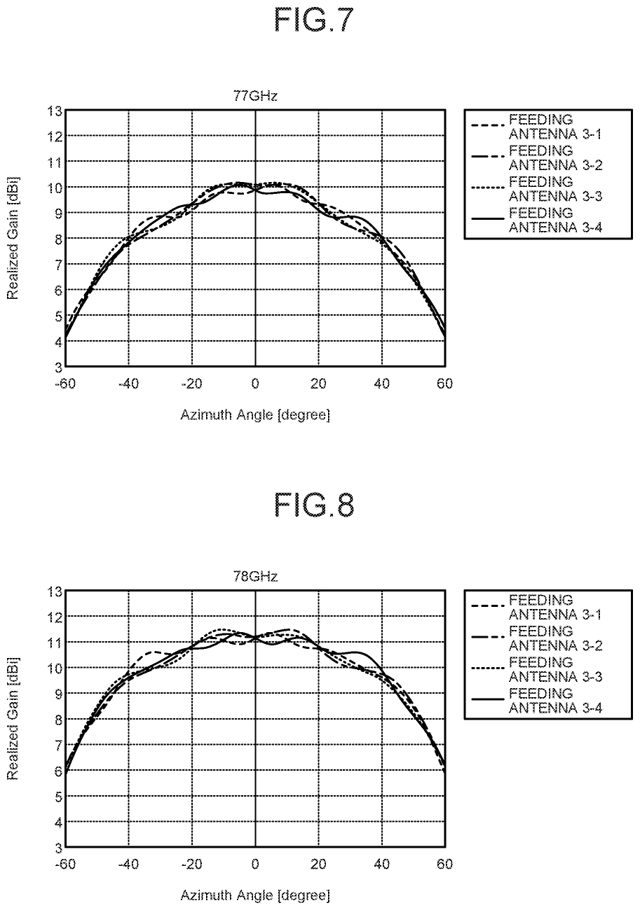

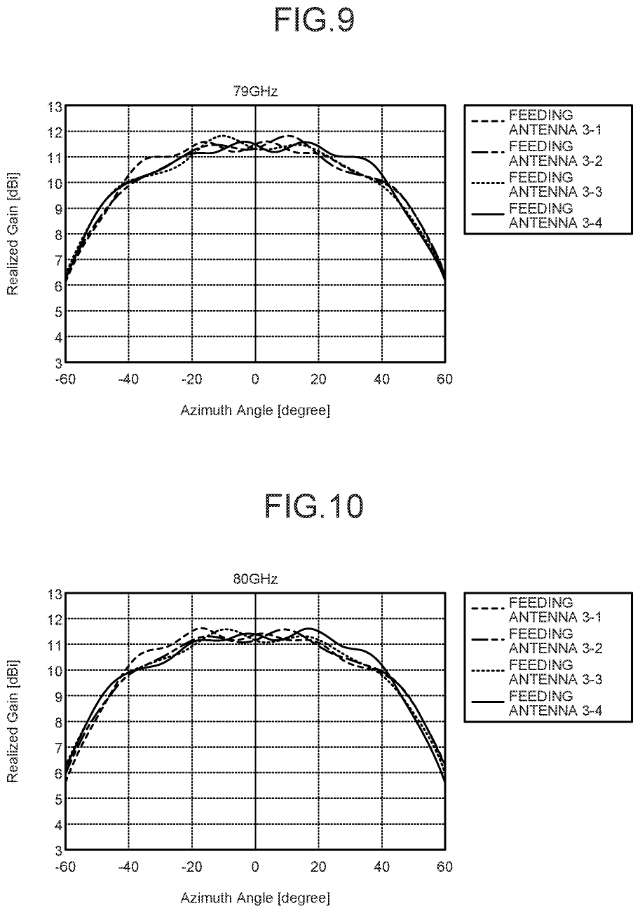

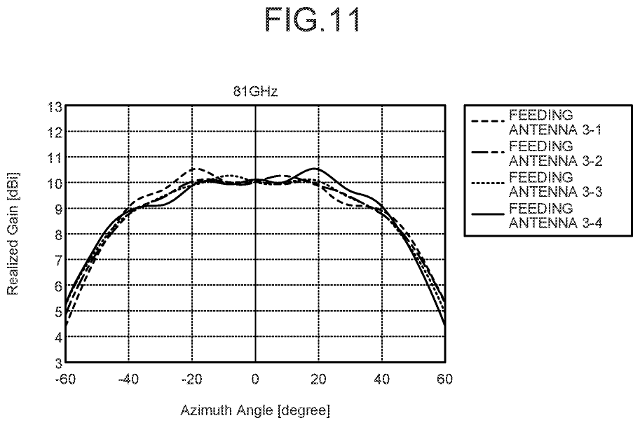

Since the SIW 52 gives a large attenuation amount over a wide band in this way, the terminators 5 terminate the parasitic antennas 4 over a wide band. As a result, variations in the radiation characteristics of the plurality of feeding antennas 3 are suppressed over a wide band. Examples of suppression of variations by the antenna device 1 are explained with reference to FIG. 7 to FIG. 11. In the following explanation, the variations in the radiation characteristics of the plurality of feeding antennas 3 are sometimes simply referred to as “variations in radiation characteristics”.

FIG. 7 to FIG. 11 are diagrams illustrating examples of radiation characteristics of a plurality of feeding antennas. The horizontal axis of a graph indicates an angle (°) and the vertical axis of the graph indicates an antenna gain (dBi). The angle is an angle on a YZ plane, and an angle of 0° is equivalent to the Z-axis positive direction, an angle of 90° is equivalent to the Y-axis negative direction, and an angle of −90° is equivalent to the Y-axis positive direction.

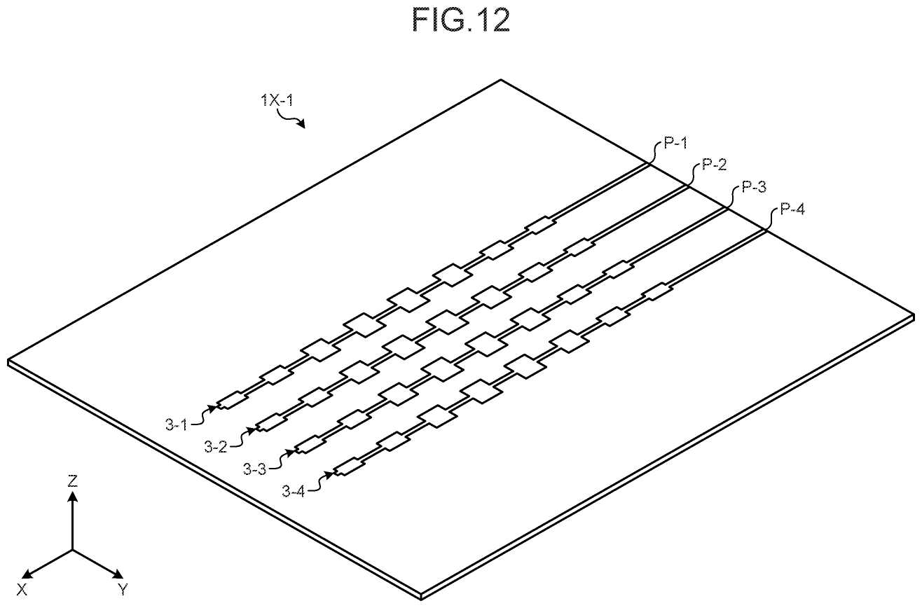

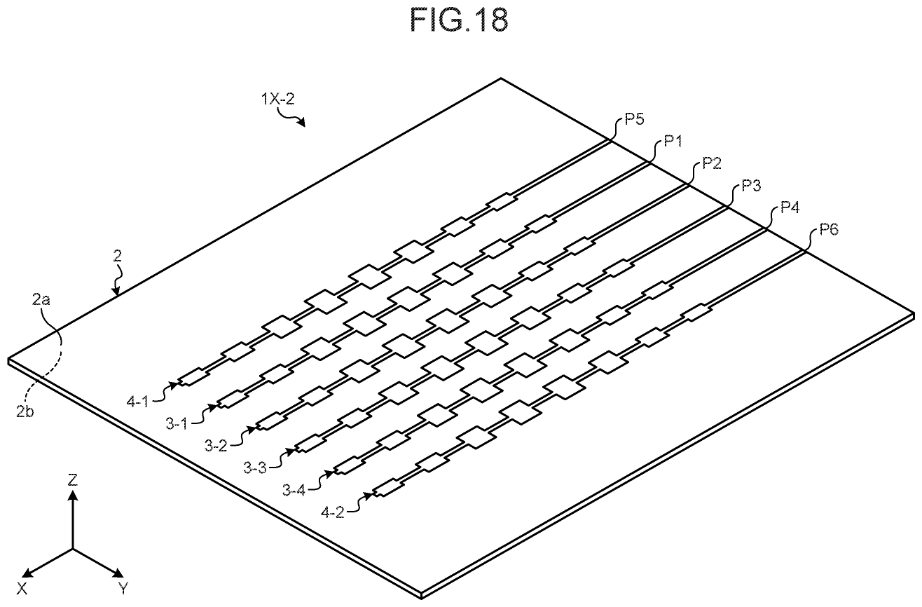

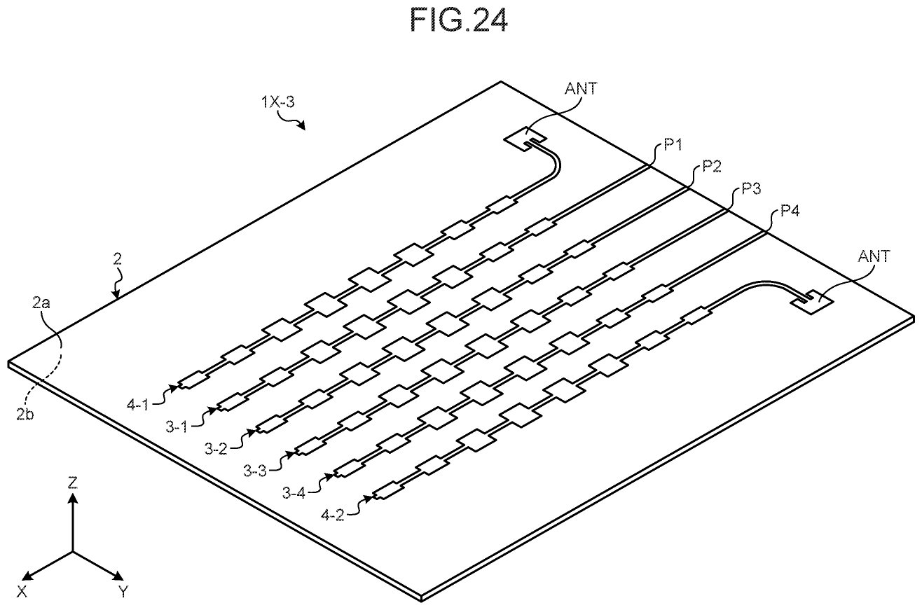

In FIG. 7 to FIG. 11, radiation characteristics of the feeding antenna 3-1, the feeding antenna 3-2, the feeding antenna 3-3, and the feeding antenna 3-4 at the time when a frequency is 77 GHz to 81 GHz are illustrated. As it is understood from comparison with several comparative examples explained below, variations in the radiation characteristics are suppressed to a level close to an ideal state. As the comparative examples, an antenna device 1X-1 (FIG. 12), an antenna device 1X-2 (FIG. 18), and an antenna device 1X-3 (FIG. 24) are explained as examples.

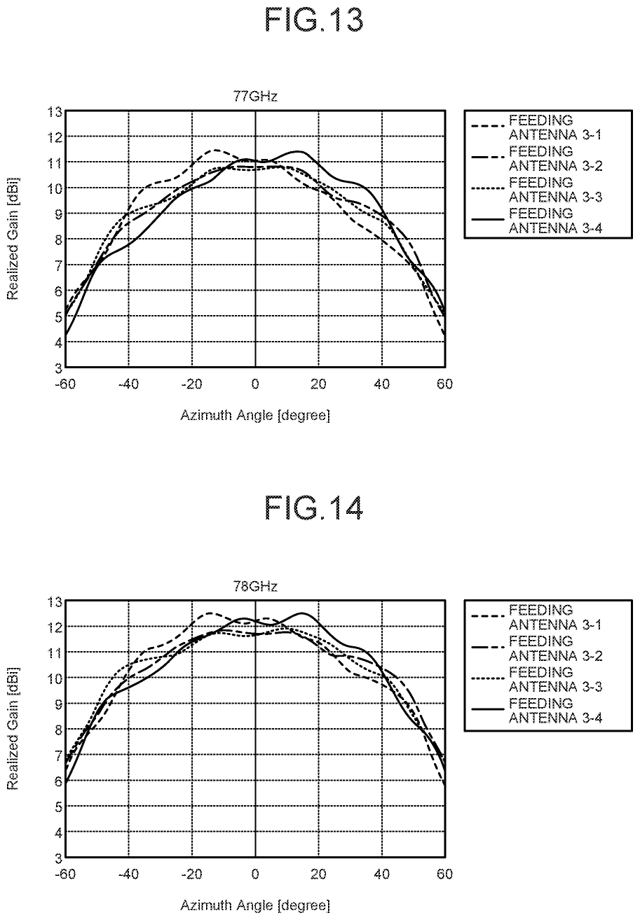

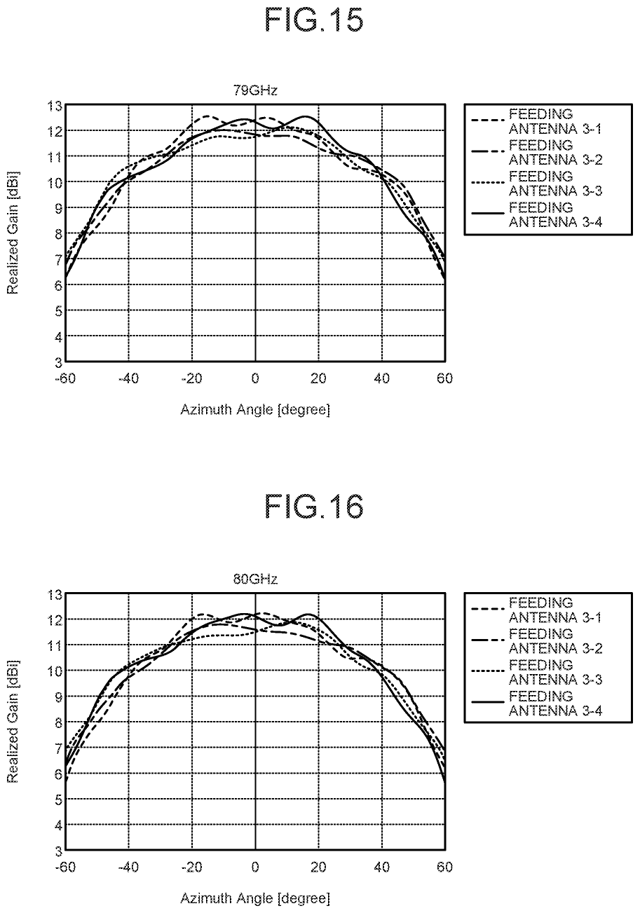

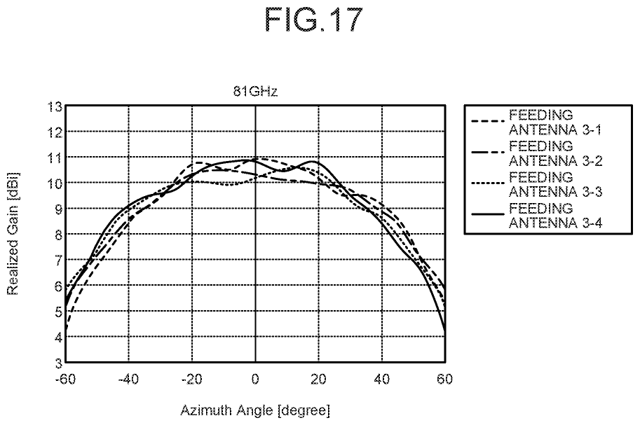

The antenna device 1X-1 illustrated in FIG. 12 includes neither the parasitic antennas 4 nor the terminators 5 included in the antenna device 1 (FIG. 1). FIG. 13 to FIG. 17 illustrate radiation characteristics of the plurality of feeding antennas 3 in the antenna device 1X-1. The variations in the radiation characteristics (FIG. 7 to FIG. 11) in the antenna device 1 according to the embodiment described above are suppressed more than the variations in the radiation characteristics in the antenna device 1X-1.

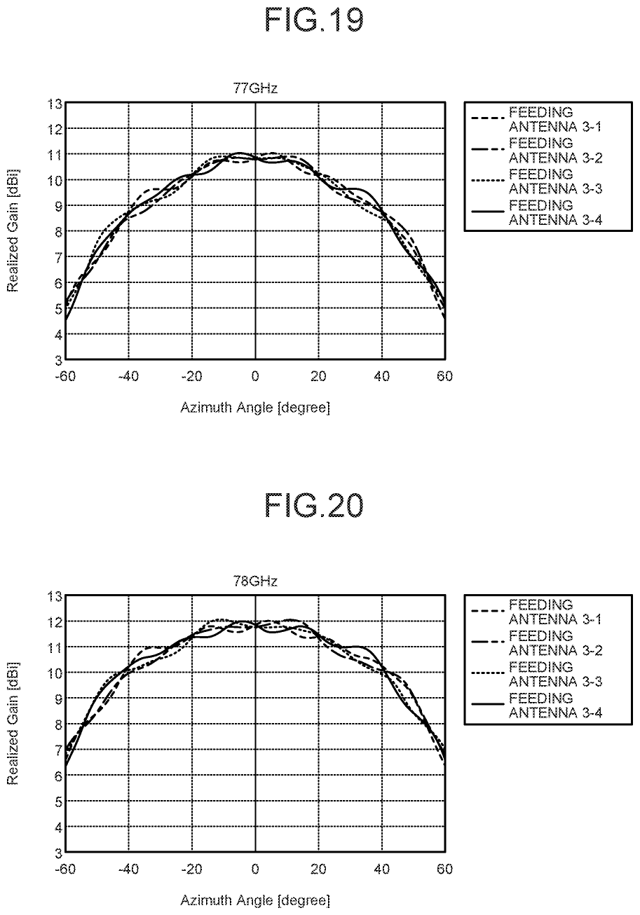

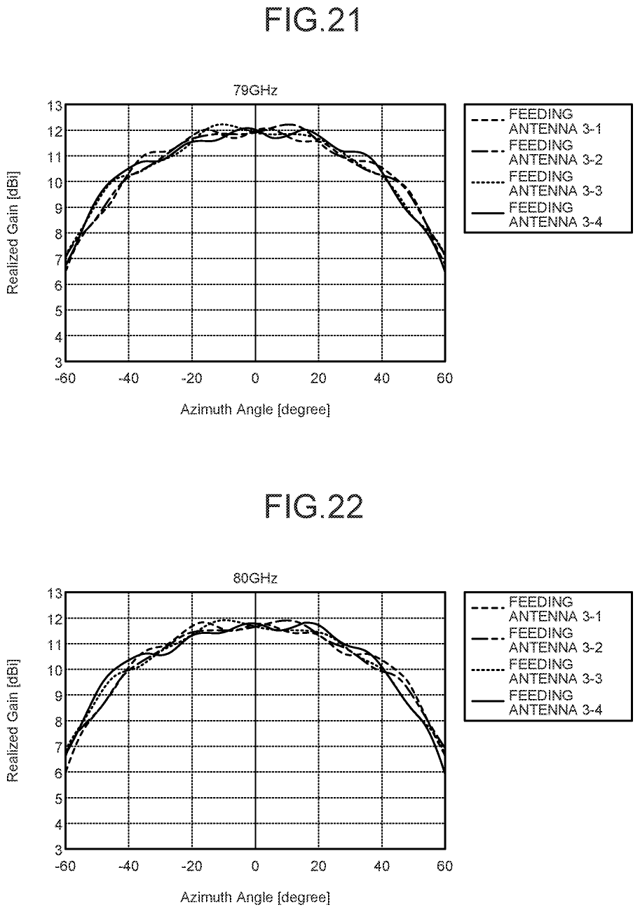

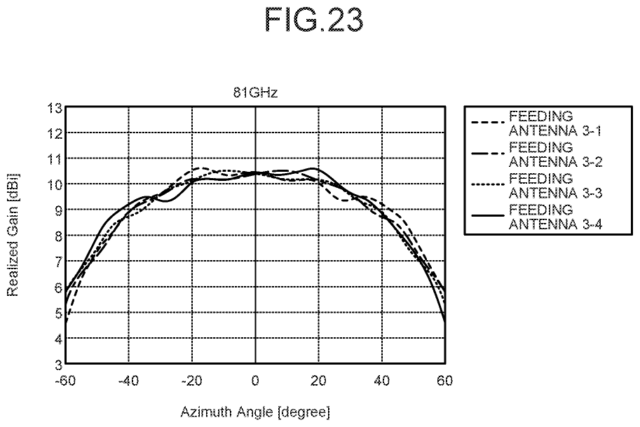

In the antenna device 1X-2 illustrated in FIG. 18, the parasitic antennas 4 are connected not to the terminators 5 but to a port P5 and a port P6. The port P5 and the port P6 function as ideal terminators (return loss of which is infinite at all frequencies). In FIG. 19 to FIG. 23, radiation characteristics of the plurality of feeding antennas 3 in the antenna device 1X-2 are illustrated. The variations in the radiation characteristics (FIG. 7 to FIG. 11) in the antenna device 1 according to the embodiment explained above are suppressed to a level close to the variations in the radiation characteristics in the antenna device 1X-2.

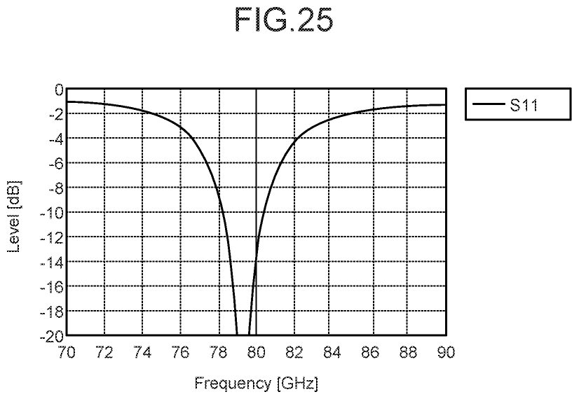

In the antenna device 1X-3 illustrated in FIG. 24, the parasitic antennas 4 are terminated not by the terminators 5 but by termination antennas ANT. The termination antennas ANT are polarized wave antennas orthogonal to a polarized wave of the feeding antenna 3 explained in Patent Literature 1. FIG. 25 is a diagram illustrating an example of a simulation result of termination characteristics of the termination antennas ANT in FIG. 24 explained above. A return loss of −10 dB or less is only obtained in a narrow bandwidth (approximately 2 GHz) centering on 79 GHz, which is a resonance frequency.

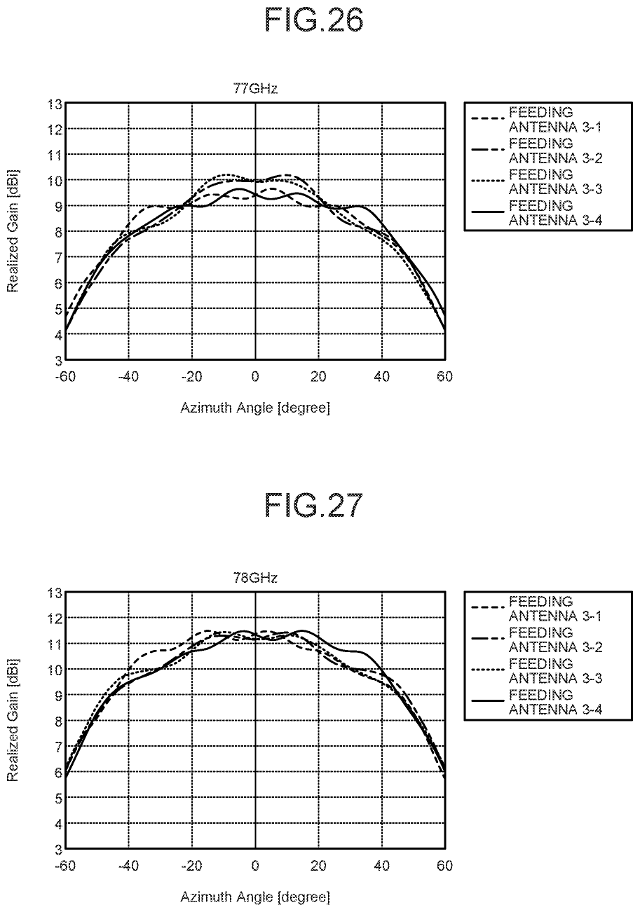

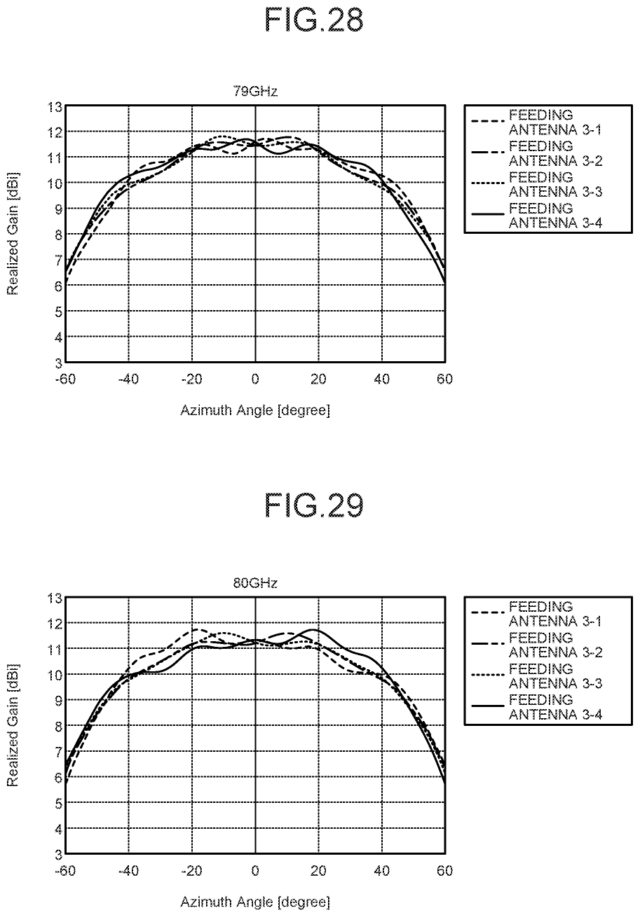

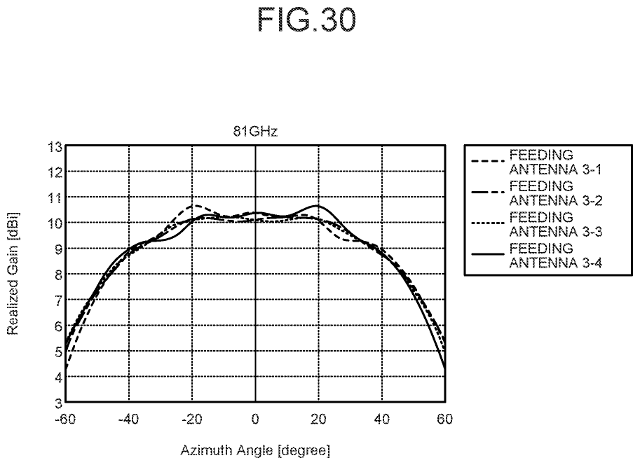

In FIG. 26 to FIG. 30 illustrate radiation characteristics of the plurality of feeding antennas 3 in the antenna device 1X-3. The variations in the radiation characteristics (FIG. 7 to FIG. 11) in the antenna device 1 according to the embodiment explained above are suppressed more than the variations in the radiation characteristics in the antenna device 1X-3. The effects of the suppression are more conspicuous as a frequency is farther from the resonance frequency 79 GHz of the termination antennas ANT. This is because the terminators 5 of the antenna device 1 give a larger attenuation amount over a wide band than the termination antennas ANT of the antenna device 1X-3.

As explained above, with the antenna device 1 according to the embodiment, the terminators 5 terminate the parasitic antennas 4 over a wide band and variations in radiation characteristics are suppressed.

In the antenna device 1X-3 according to the comparative example explained above with reference to FIG. 24 and the like, it is likely that re-radiation due to the termination antennas ANT occurs and, for example, the characteristics of the antenna device 1 are deteriorated by the re-radiation. With the antenna device 1 according to the embodiment, such problems do not occur.

Further, with the antenna device 1, since the terminators 5 is configured using the SIWs 52, the terminators 5 are integrated on the substrate 2. Accordingly, the antenna device 1 can be downsized. In particular, since the substrate 2 is a multilayer substrate and the SIW 521, the SIW 522, and the SIW 523 each extending a different layer are included in the SIW 52, the integration degree of the SIW 52 on the substrate 2 can be increased, and the antenna device 1 can be further downsized.

### 2. MODIFICATION

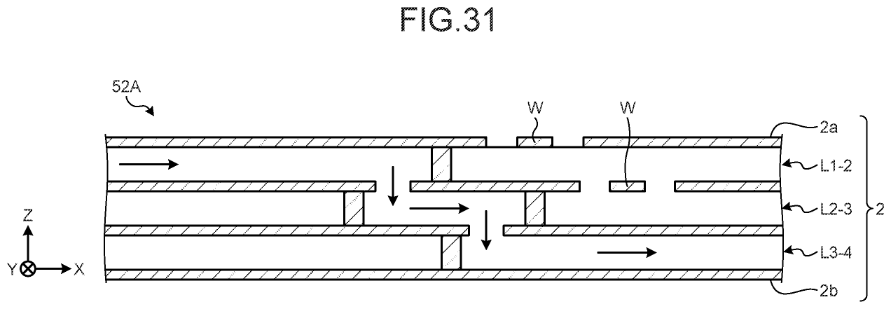

Several modifications are explained with reference to FIG. 31 to FIG. 44. An SIW may be provided on the substrate 2 to extend in the substrate 2 in various forms. An SIW 52A illustrated in FIG. 31 extends in the substrate 2 to avoid wires W provided on the substrate 2. Examples of the wires W are a signal line, a power line, and the like. In this example, the SIW 52A extends in the layer L1-2 and transitions from the layer L1-2 to the layer L2-3 to avoid the wires W provided on the upper surface of layer L1-2, and extends in the layer L2-3. Further, the SIW 52A transitions from the layer L2-3 to the layer L3-2 to avoid the wires W provided on the upper surface of the layer L2-3 (or the lower surface of the layer L1-4) and extends in the layer L3-4.

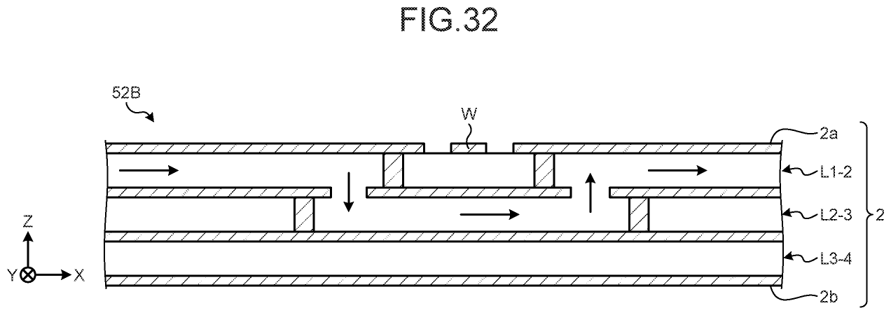

An SIW 52B illustrated in FIG. 32 transitions to another layer in order to avoid the wires W, and after avoiding the wires W, transitions to the original layer and extends again. In this example, the SIW 52B transitions from the layer L1-2 to the layer L2-3 in order to avoid the wires W provided on the upper surface of the layer L1-2 and extends in the layer L2-3. After avoiding the wires W, the SIW 52B transitions from the layer L2-3 to the layer L1-2 and extends in the layer L1-2 again.

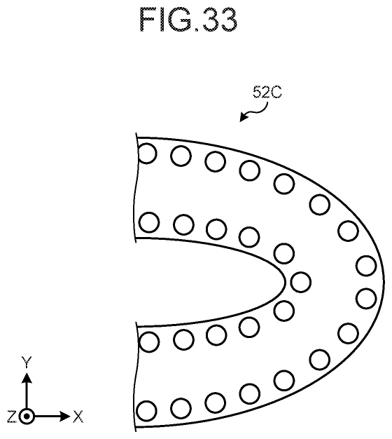

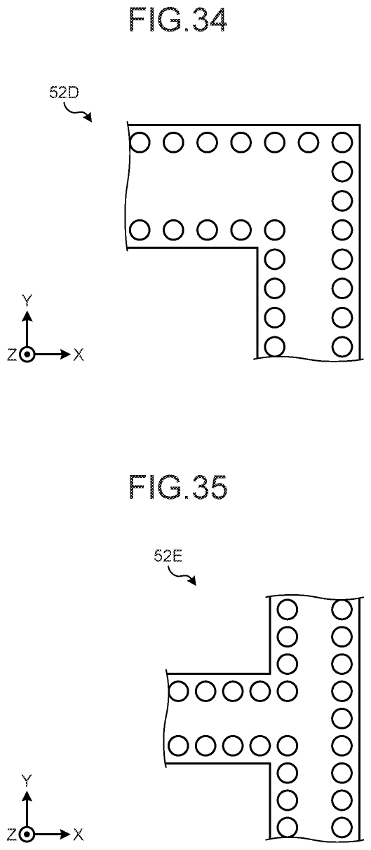

The SIW may extend in the substrate 2 while, for example, curving, bending, or branching in the substrate 2. An SIW 52C illustrated in FIG. 33 has a curved portion. However, a degree of the curving (a curvature radius or the like) is not limited to an example illustrated in FIG. 33. An SIW 52D illustrated in FIG. 34 includes a bent portion bent at approximately 90°. However, a bending angle is not limited to an example illustrated in FIG. 34. An SIW 52E illustrated in FIG. 35 has a branch portion that branches in a T shape. However, a form of the branching is not limited to an example illustrated in FIG. 35.

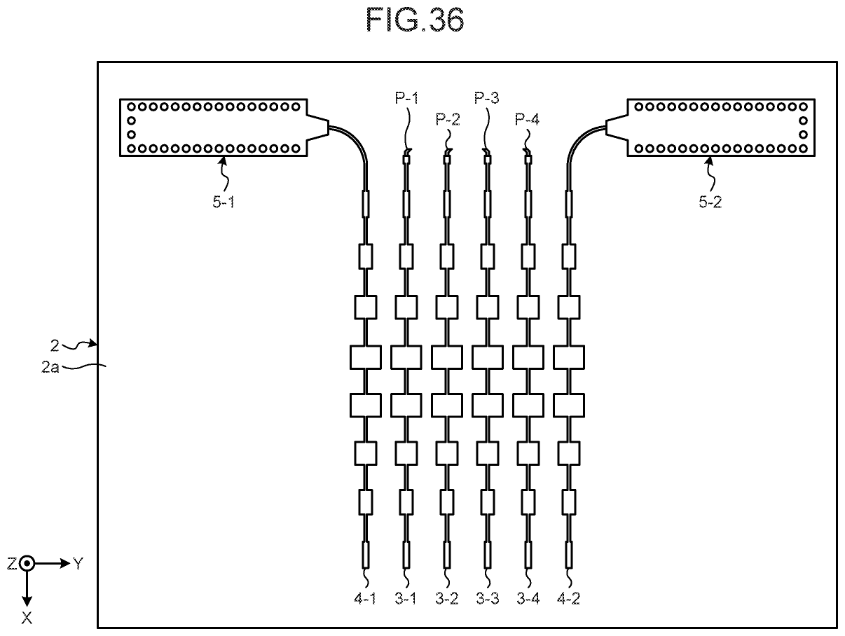

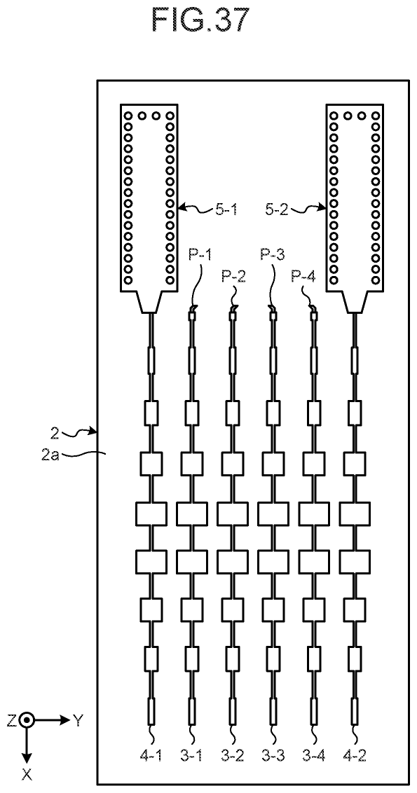

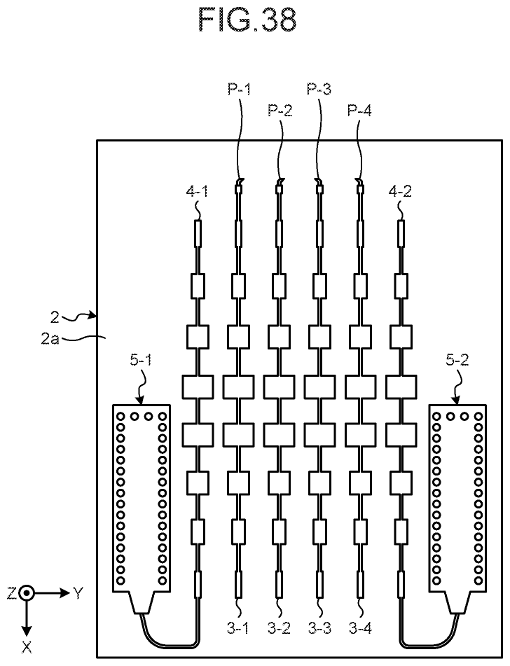

Various modes may also be adopted for the disposition of the terminators 5 with respect to the parasitic antennas 4. For example, the direction of the terminators 5 is not limited to an example illustrated in FIG. 1. As illustrated in FIG. 36, the terminators 5 may be provided with respect to the parasitic antennas 4 such that an extending direction of the terminators 5 crosses an extending direction of the parasitic antennas 4. A layout of connection portions (microstrip lines) between the parasitic antennas 4 and the terminators 5 is changed as appropriate according to a disposition change. As illustrated in FIG. 37, the terminators 5 may be provided on extension lines in the extending direction of the parasitic antennas 4. As illustrated in FIG. 38, the terminators 5 may be connected to end portions (end portions on the X-axis positive direction side) opposite to the end portions (the end portions on the X-axis negative direction side) of the parasitic antennas 4 explained above.

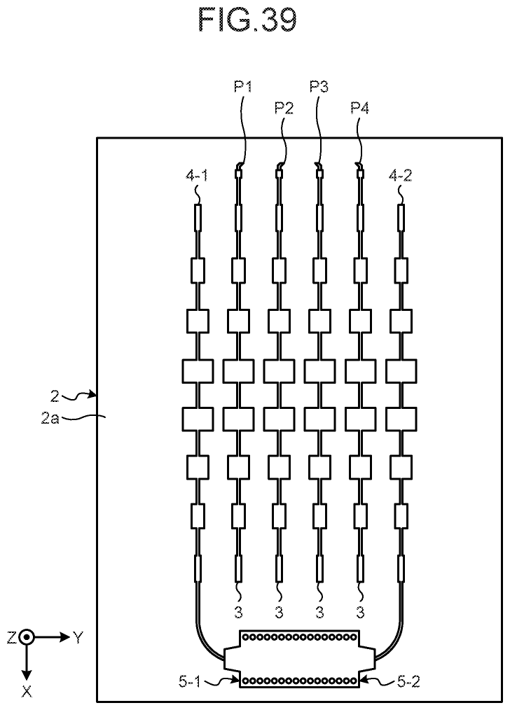

The parasitic antennas 4 may share one terminator. In an example illustrated in FIG. 39, one terminator including two inputs is shared by the parasitic antenna 4-1 and the parasitic antenna 4-2. Since this terminator can also be regarded as having the functions of both of the terminator 5-1 and the terminator 5-2 explained above, the terminator is illustrated using those reference numerals.

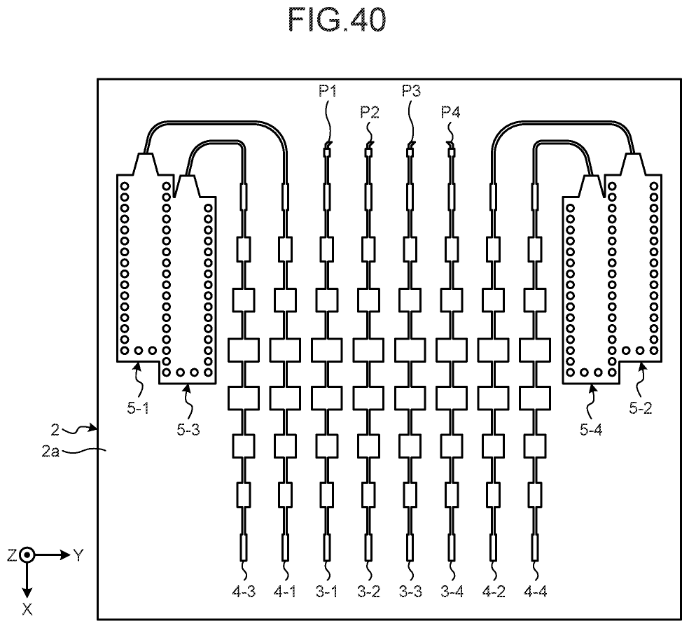

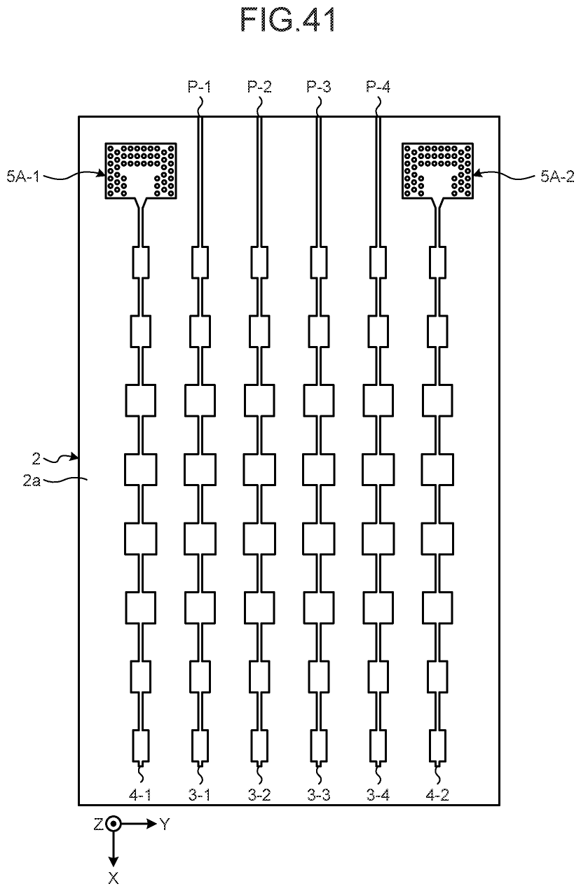

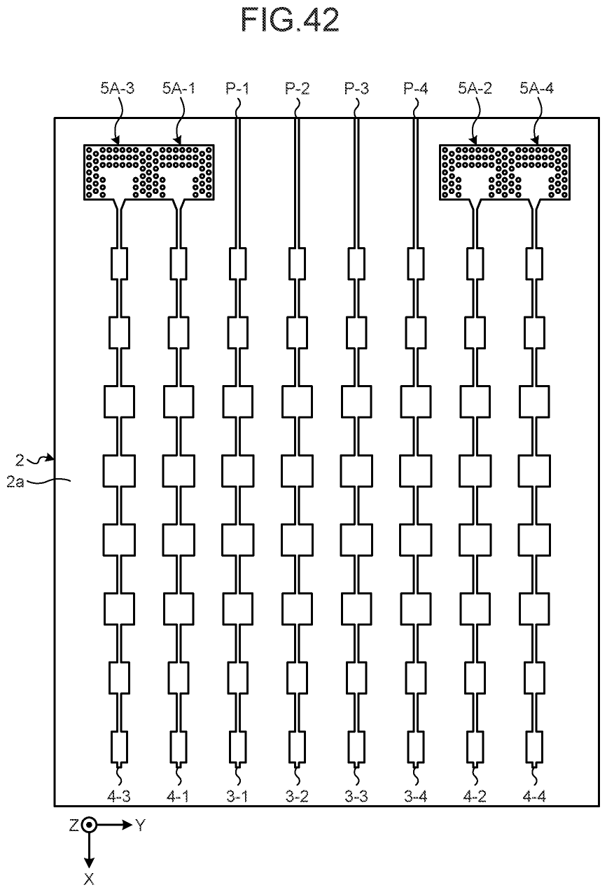

Additional parasitic antennas 4 and terminators 5 may be provided. In an example illustrated in FIG. 40, a parasitic antenna 4-3 and a parasitic antenna 4-4 and terminators 5-3 and 5-4 corresponding thereto are further provided. The parasitic antenna 4-3 is provided on the opposite side of the feeding antenna 3-1 across the parasitic antenna 4-1 and is terminated by the terminator The parasitic antenna 4-4 is provided on the opposite side of the feeding antenna 3-4 across the parasitic antenna 4-2 and is terminated by the terminator 5-4. The terminator 5-1 and the terminator 5-3 are disposed adjacent to each other to share at least a part of vias. The terminator 5-2 and the terminator 5-4 are disposed adjacent to each other to share at least a part of the vias.

The terminators 5 may be provided on the substrate 2 to reduce the area of the main surface 2a of the substrate 2 occupied by the terminators 5. For terminators 5A illustrated in FIG. 41, the pattern area of the main surface 2a of the substrate 2 in use is smaller compared with the terminators 5 (FIG. 1 and the like). Of the illustrated two terminators 5A, a terminator 5A-1 corresponds to the parasitic antenna 4-1 and a terminator corresponds to the parasitic antenna 4-2. The terminator 5A has, for example, a configuration in which the SIW 521 (FIG. 2 and the like) of the terminators 5 are set shorter than the SIW 522 and the SIW 523.

In an example illustrated in FIG. 42, the parasitic antenna 4-3 and the parasitic antenna 4-4 and a terminator 5A-3 and a terminator 5A-4 corresponding thereto are further provided. The terminator 5A-1 and the terminator 5A-3 are disposed adjacent to each other to share at least a part of the vias. The terminator 5A-2 and the terminator 5A-4 are disposed adjacent to each other to share at least a part of the vias.

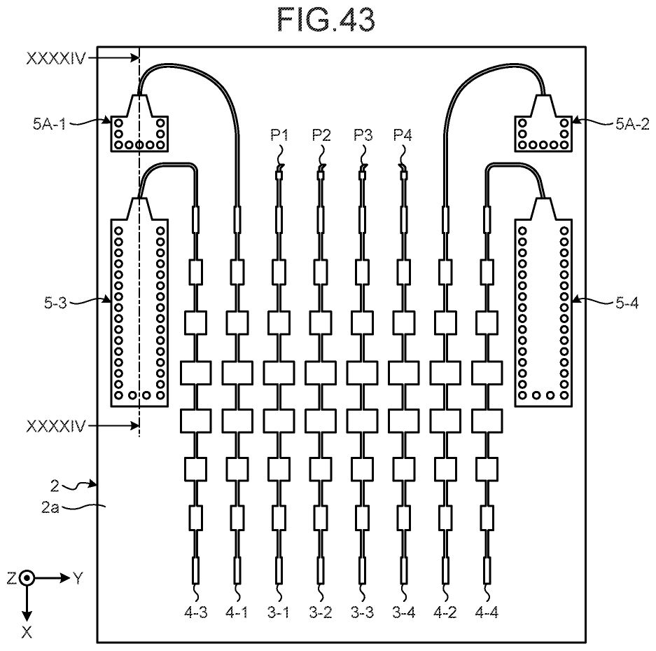

In an example illustrated in FIG. 43, the terminator 5A-1 and the terminator 5A-2 are provided to correspond to the parasitic antenna 4-1 and the parasitic antenna 4-2 and the terminator 5-3 and the terminator 5-4 are provided to correspond to the parasitic antenna 4-3 and the parasitic antenna 4-4. A part of SIWs of the terminator 5A-1 extends below (in the Z-axis negative direction) SIWs of the terminator 5-3. A part of SIWs of the terminator 5A-3 extends below SIWs of the terminator 5-4.

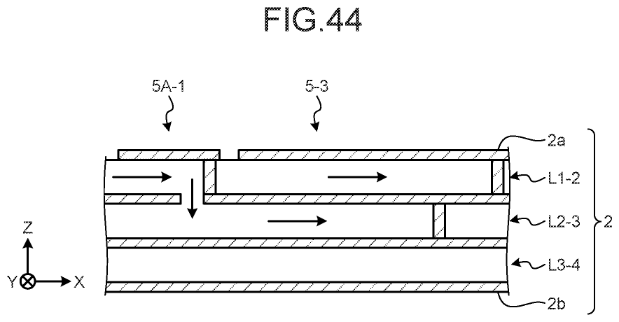

In FIG. 44, a partial cross-sectional view of the terminator 5A-1 and the terminator 5-3 taken along a line XXXXIV in FIG. 43 is schematically illustrated. In this example, the SIWs of terminator 5A-1 extend in the layer L1 2 only a little and, thereafter, immediately transitions to the layer L2-3 and extends through layer L2-3. A part of the SIWs of terminator 5A-1 extending in layer L2-3 is located below the SIWs of terminator 5-3 extending in layer L1-2. The same applies to the terminator 5A-2 and the terminator 5-4 (FIG. 43).

Although the embodiment of the present disclosure is explained above, the technical scope of the present disclosure is not limited to the embodiment explained above per se. Various changes are possible without departing from the gist of the present disclosure. Components in different embodiments and modifications may be combined as appropriate.

In the embodiment explained above, an example in which the substrate 2 is a three-layer substrate including the layer L1-\hat{ }2, the layer L2-3, and the layer L3-4 is explained. However, the number of layers of the substrate 2 is not particularly limited. The substrate 2 may be a single-layer substrate, a two-layer substrate, or a multilayer substrate including four or more layers. The SIW 52 of the terminator 5 may include SIWs as many as the layers of the substrate 2.

In the embodiment explained above, an example is explained in which the number of feeding antennas 3 is four. However, the number of feeding antennas 3 is not particularly limited. The number of feeding antennas 3 may be any integer equal to or larger than 1.

In the embodiment explained above, the frequency band of 77 GHz to 81 GHz is mainly described as an example of the frequency band of the antenna device 1. However, the frequency band of the antenna device 1 may be changed as appropriate according to a use of the antenna device 1. For example, as will be explained below, the antenna device 1 may be used for a radar device, a communication device, or the like. In that case, the frequency band of the antenna device 1 is decided to be match a frequency band of the radar device, the communication device, or the like. Examples of the frequency band of the radar device are a 76 GHz band (76 GHz to 77 GHz), a 24 GHz band (24.05 GHz to 24.25 GHz), a 60 GHz band (60 GHz to 61 GHz), and the like besides the 79 GHz band (77 GHz to 81 GHz) explained above. Examples of the frequency band of the communication device are a 28 GHz band (27.0 to 29.5 GHz), a 60 GHz band (57 GHz to 64 GHz), and the like.

### 3. APPLICATION EXAMPLES

3.1 Application Example to a Radar Device

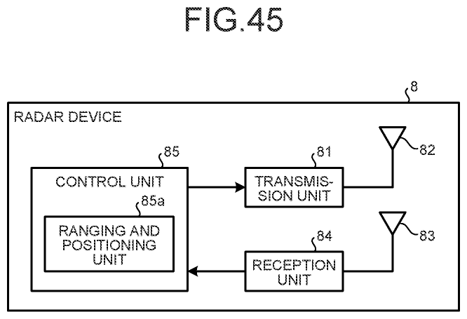

An application example to the radar device is explained with reference to FIG. 45.

FIG. 45 is a block diagram illustrating an example of a schematic configuration of the radar device. The radar device 8 includes a transmission unit 81, an antenna device 82, an antenna device 83, a reception unit 84, and a control unit 85.

The transmission unit 81 performs transmission processing. The transmission processing can include modulation processing, frequency conversion processing (up-conversion), amplification processing, filtering processing, and the like. An example of modulation is FM modulation. However, various types of modulation suitable for a radar may be used besides the FM modulation.

The antenna device 82 transmits (radiates) a transmission signal. The antenna device 83 receives a part of signals reflected by a not-illustrated object among transmission signals transmitted from the antenna device 82. Examples of the object are a vehicle, a person, a building, and the like.

The reception unit 84 performs reception processing. The reception processing can include amplification processing, filtering processing, frequency conversion processing (down conversion), demodulation processing, and the like.

The control unit 85 performs overall control of the radar device 8. The control by the control unit 85 includes processing of a transmission signal by the transmission unit 81 and processing of a reception signal by the reception unit 84. The signal processing includes, for example, detection of the distance to an object (distance measurement) and detection of the direction of an object (positioning). As a functional block that performs such signal processing (distance measurement and/or positioning), a ranging/positioning section 85a is illustrated in FIG. 44. Since a method of distance measurement and positioning itself is publicly known, detailed explanation thereof is omitted here.

In the radar device 8 explained above, the antenna device 1 (FIG. 1) and the like according to the embodiment explained above are used as, for example, the antenna device 82 and/or the antenna device 83. Consequently, variations in the radiation characteristics of the plurality of feeding antennas 3 are suppressed over a wide band. When the variations in the radiation characteristics is large, it is likely that a deficiency occurs in signal processing or the like and radar performance is deteriorated. However, such a deficiency is also suppressed by suppressing the variations in the radiation characteristics. As a result, the radar performance of the radar device 8 can be improved.

3.2 Application Example to a Communication Device

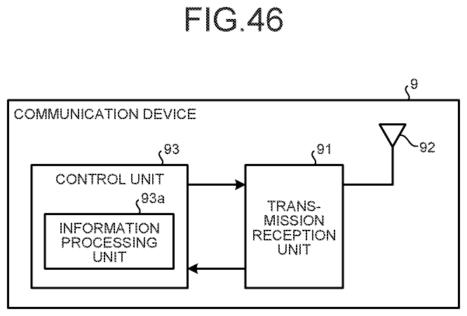

An application example to the communication device is explained with reference to FIG. 46.

FIG. 46 is a block diagram illustrating an example of a schematic configuration of a communication device. A communication device 9 is, for example, a mobile terminal device such as a smartphone and includes a transmission and reception unit 91, an antenna device 92, and a control unit 93.

The transmission and reception unit 91 performs transmission and reception processing. The transmission and reception processing can include modulation and demodulation processing, frequency conversion processing (up-convert and down-convert), amplification processing, and filtering processing.

The antenna device 92 transmits a transmission signal to a communication partner device. An example of the communication partner device is a base station. The antenna device 92 receives a signal from the communication partner device.

The control unit 93 performs overall control of the communication device 9. The control by the control unit 93 includes processing of transmission and reception signals. For example, processing of various kinds of information obtained by transmission and reception is also included in the control by the control unit 93. In FIG. an information processing unit 93a is illustrated as a functional block that performs the information processing. In the communication device 9 explained above,

the antenna device 1 (FIG. 1) and the like according to the embodiment explained above are used as, for example, the antenna device 92. Since the variations in the radiation characteristics of the plurality of feeding antennas 3 are suppressed over a wide band, wireless communication performance of the communication device 9 can be improved.

Note that, besides the radar device and the communication device explained above, the antenna device 1 according to the embodiment can be applied to various techniques. For example, the antenna device 1 may also be used for a robot, an unmanned flying body, and the like.

### 4. EFFECTS

The antenna device 1 explained above is specified, for example, as follows. As explained with reference to FIG. 1 and the like, the antenna device 1 includes the one or the plurality of feeding antennas 3 provided (for example, side by side) on the main surface 2a of the substrate 2, the parasitic antennas 4 provided (for example, further on the outer side of the outermost feeding antenna 3 among the plurality of feeding antennas 3) on the main surface 2a of the substrate 2, and the terminators 5 provided on the substrate 2 and connected to the parasitic antennas 4. The terminators 5 include the SIWs 52, which are the waveguides extending in the substrate 2.

With the antenna device 1 explained above, the parasitic antennas 4 are terminated over a wide band by the terminators 5 including the SIWs 52. As a result, for example, as explained above with reference to FIG. 7 to FIG. 11 and the like, it is possible to suppress variations in the radiation characteristics of the plurality of feeding antennas 3 over a wide band.

In the antenna device 1X-3 according to the comparative example explained above with reference to FIG. 24 and the like, it is likely that re-radiation due to the termination antennas ANT occurs and, for example, the characteristics of the antenna device 1 are deteriorated by the re-radiation. According to the antenna device 1, such a problem does not occur.

Further, in the antenna device 1, since the terminators 5 including the SIWs 52 are integrated on the substrate 2, the antenna device 1 can be downsized.

As explained with reference to FIG. 2 and FIG. 3 and the like, the substrate 2 is the multilayer substrate and the SIWs 52 may include the SIW 521 extending the layer L1-2 (the first layer) and the SIW 522 extending the layer L2-3 (the second layer). Since the SIW 52 includes the plurality of SIWs respectively extending the different layers of the substrate 2, it is possible to increase a degree of integration of the terminators 5 on the substrate 2. As a result, the terminators 5 and the antenna device 1 can be further downsized.

As explained with reference to FIG. 2 and FIG. 3 and the like, the SIW 521 and the SIW 522 may be connected in series via the opening 521d and the opening 522d that cause the layer L1-2 and the layer L2-3 to communicate. Consequently, it is possible to secure the length of the SIWs 52 and give a large attenuation amount. By connecting, in series, the plurality of SIWs respectively extending in the different layers of the substrate 2, it is possible to further keep the characteristic impedance constant (prevent impedance mismatching) and further suppress reflection than in the case in which the SIWs are connected in parallel.

As explained with reference to FIG. 2 and FIG. 3 and the like, the SIW 522 may extend in the direction (the X-axis negative direction) opposite to the extending direction (the X-axis positive direction) of the SIW 521. When the substrate 2 is viewed in a plan view, at least parts of the SIW 521 and the SIW 522 may overlap. Consequently, it is possible to reduce the area of the SIW 52 occupying the substrate 2 and further improve the degree of integration of the terminators 5 on the substrate 2. As a result, the terminators 5 and the antenna device 1 can be further downsized.

As explained with reference to FIG. 2, FIG. 3, and FIG. 41 to FIG. 44, and the like, the SIW 521 extending in the layer L1-2 may be shorter than the SIW 522 extending in the layer L2-3. Consequently, the area of the main surface 2a of the substrate 2 occupied by the terminator 5 can be reduced.

As explained with reference to FIG. 1 and FIG. 2 and the like, the SIW 52 may have a constant width. The terminator 5 may include the microstrip lines 51 connected between the parasitic antennas 4 and the SIWs 52. Consequently, for example, the SIWs 52 having a width that gives a desired attenuation amount can be directly connected to the parasitic antennas 4 via the microstrip lines 51. The microstrip lines 51 may include a portion (the second portion 512) having a tapered shape. Consequently, matching between the microstrip lines 51 and the SIWs 52 can be improved.

As explained with reference to FIG. 45 and the like, the antenna device 1 may be mounted on the radar device 8 (for example, as the antenna device 82 and/or the antenna device 83). Consequently, the radar performance of the radar device 8 can be improved. As explained with reference to FIG. 46 and the like, the antenna device 1 may be mounted on the communication device 9 (for example, as the antenna device 92). Consequently, the wireless communication performance of the communication device 9 can be improved.

The terminators 5 explained with reference to FIG. 1 and FIG. 2 and the like are also an aspect of the present disclosure. That is, the terminators 5 include the SIWs 52, which are the waveguides extending in the substrate 2, the substrate 2 is the multilayer substrate, and the SIWs 52 include the SIW 521 extending the layer L1-2 (the first layer) and the SIW 522 extending the layer L2-3 (the second layer). Such terminators 5 provides a large attenuation amount over a wide band as explained above. For example, by using the terminators 5 in the antenna device 1, variations in the radiation characteristics of the plurality of feeding antennas 3 can be suppressed. The terminators 5 may be specified as follows.

That is, the terminators 5 includes the SIWs 52, which are waveguides extending in the substrate 2, and the microstrip lines 51 connected to the SIWs 52, and the SIWs 52 have a constant width. Consequently, for example, the SIWs 52 having a width that gives a desired attenuation amount can be directly connected to termination targets (for example, parasitic antennas) via the microstrip lines 51. The communication device 9 explained with

reference to FIG. 1 and FIG. 46 and the like is also an aspect of the terminal device. That is, the terminal device is the communication device 9 and includes the transmission and reception unit 91, the control unit 93, and the antenna device 92, the antenna device 92 includes the one or the plurality of feeding antennas 3 provided on the main surface 2a of the substrate 2, the parasitic antennas 4 provided on the main surface 2a of the substrate 2, and the terminators 5 provided on the substrate 2 and connected to the parasitic antennas 4, and the terminators 5 include the SIWs 52, which are waveguides extending in the substrate 2. Even with such a communication device 9, as explained above, it is possible to suppress variations in the radiation characteristics of the plurality of feeding antennas 3 over a wide band.

The radar device 8 explained with reference to FIG. 1 and FIG. 45 and the like is also an aspect of the terminal device. That is, the terminal device is the radar device 8 and includes the transmission unit 81, the reception unit 84, the control unit 85, and the antenna device 82 and/or the antenna device 83, the antenna device 82 and/or the antenna device 83 includes the one or the plurality of feeding antennas 3 provided on the main surface 2a of the substrate 2, the parasitic antennas 4 provided on the main surface 2a of the substrate 2, and the terminators 5 provided on the substrate 2 and connected to the parasitic antennas 4, and the terminators 5 include the SIWs 52, which are waveguides extending in the substrate 2. With such a radar device 8 as well, as explained above, it is possible to suppress variations in the radiation characteristics of the plurality of feeding antennas 3 over a wide band.

The effects described in the present disclosure are only examples and are not limited to the disclosed contents. There may be other effects.

Although the embodiment of the present disclosure is explained above, the technical scope of the present disclosure is not limited to the embodiment explained above per se. Various changes are possible without departing from the gist of the present disclosure. Components in different embodiments and modifications may be combined as appropriate.

Note that the present technique can also take the following configurations.
(1) An antenna device comprising:
   one or a plurality of feeding antennas provided on a main surface of a substrate;
   a parasitic antenna provided on the main surface of the substrate; and
   a terminator provided on the substrate and connected to the parasitic antenna, wherein
   the terminator includes an SIW that is a waveguide extending in the substrate.
(2) The antenna device according to (1), wherein
   the substrate is a multilayer substrate, and
   the SIW includes:
   a first SIW extending in a first layer of the substrate; and
   a second SIW extending in a second layer of the substrate.
(3) The antenna device according to (2), wherein
   the first SIW and the second SIW are connected in series via an opening that causes the first layer and the second layer to communicate.
(4) The antenna device according to (2) or (3), wherein
   the second SIW extends in a direction opposite to an extending direction of the first SIW.
(5) The antenna device according to (4), wherein
   at least parts of the first SIW and the second SIW overlap when the substrate is viewed in a plan view.
(6) The antenna device according to any one of (2) to (4), wherein
   the first SIW extending in the first layer is shorter than the second SIW extending in the second layer.
(7) The antenna device according to any one of (1) to (6), wherein
   the SIW has a constant width.
(8) The antenna device according to any one of (1) to (7), wherein
   the terminator includes a microstrip line connected between the parasitic antenna and the SIW.
(9) The antenna device according to (8), wherein
   the microstrip line includes a portion having a tapered shape.
(10) The antenna device according to any one of (1) to (9), wherein
   the antenna device is mounted on a radar device.
(11) The antenna device according to any one of (1) to (9), wherein
   the antenna device is mounted on a communication device.
(12) A terminator comprising
   an SIW that is a waveguide extending in a substrate, wherein
   the substrate is a multilayer substrate, and
   the SIW includes:
   a first SIW extending in a first layer; and
   a second SIW extending in a second layer.
(13) A terminator comprising:
   an SIW that is a waveguide extending in a substrate; and
   a microstrip line connected to the SIW, wherein
   the SIW has a constant width.
(14) A terminal device comprising
   a transmission and reception unit, a control unit, and an antenna device, wherein
   the terminal device is a communication device,
   the antenna device includes:
   one or a plurality of feeding antennas provided on a main surface of a substrate;
   a parasitic antenna provided on the main surface of the substrate; and
   a terminator provided on the substrate and connected to the parasitic antenna, and
   the terminator includes an SIW that is a waveguide extending in the substrate.
(15) A terminal device comprising
   a transmission unit, a reception unit, a control unit, and an antenna device, wherein
   the terminal device is a radar device,
   the antenna device includes:
   one or a plurality of feeding antennas provided on a main surface of a substrate;
   a parasitic antenna provided on the main surface of the substrate; and
   a terminator provided on the substrate and connected to the parasitic antenna, and
   the terminator includes an SIW that is a waveguide extending in the substrate.

### REFERENCE SIGNS LIST

1 ANTENNA DEVICE
2 SUBSTRATE
3 FEEDING ANTENNA
4 PARASITIC ANTENNA
5 TERMINATOR
8 RADAR DEVICE
9 COMMUNICATION DEVICE
51 MICROSTRIP LINE
52 SIW
81 TRANSMISSION UNIT
82 ANTENNA DEVICE
83 ANTENNA DEVICE
84 RECEPTION UNIT
85 CONTROL UNIT
91 TRANSMISSION RECEPTION UNIT
92 ANTENNA DEVICE
93 CONTROL UNIT
521 SIW
521a UPPER PATTERN
521b LOWER PATTERN
521c VIA
521d OPENING
522 SIW
522a UPPER PATTERN
522b LOWER PATTERN
522c VIA
522d OPENING
522e OPENING
523 SIW
523a UPPER PATTERN
523b LOWER PATTERN
523c VIA
523d OPENING

1. An antenna device comprising:
one or a plurality of feeding antennas provided on a main surface of a substrate;
a parasitic antenna provided on the main surface of the substrate; and
a terminator provided on the substrate and connected to the parasitic antenna, wherein
the terminator includes an SIW that is a waveguide extending in the substrate.

2. The antenna device according to claim 1, wherein
the substrate is a multilayer substrate, and
the SIW includes:
a first SIW extending in a first layer of the substrate; and
a second SIW extending in a second layer of the substrate.

3. The antenna device according to claim 2, wherein
the first SIW and the second SIW are connected in series via an opening that causes the first layer and the second layer to communicate.

4. The antenna device according to claim 2, wherein
the second SIW extends in a direction opposite to an extending direction of the first SIW.

5. The antenna device according to claim 4, wherein
at least parts of the first SIW and the second SIW overlap when the substrate is viewed in a plan view.

6. The antenna device according to claim 2, wherein
the first SIW extending in the first layer is shorter than the second SIW extending in the second layer.

7. The antenna device according to claim 1, wherein
the SIW has a constant width.

8. The antenna device according to claim 1, wherein
the terminator includes a microstrip line connected between the parasitic antenna and the SIW.

9. The antenna device according to claim 8, wherein
the microstrip line includes a portion having a tapered shape.

10. The antenna device according to claim 1, wherein
the antenna device is mounted on a radar device.

11. The antenna device according to claim 1, wherein
the antenna device is mounted on a communication device.

12. A terminator comprising
an SIW that is a waveguide extending in a substrate, wherein
the substrate is a multilayer substrate, and
the SIW includes:
a first SIW extending in a first layer; and
a second SIW extending in a second layer.

13. A terminator comprising:
an SIW that is a waveguide extending in a substrate; and
a microstrip line connected to the SIW, wherein
the SIW has a constant width.

14. A terminal device comprising
a transmission and reception unit, a control unit, and an antenna device, wherein
the terminal device is a communication device,
the antenna device includes:
one or a plurality of feeding antennas provided on a main surface of a substrate;
a parasitic antenna provided on the main surface of the substrate; and
a terminator provided on the substrate and connected to the parasitic antenna, and
the terminator includes an SIW that is a waveguide extending in the substrate.

15. A terminal device comprising
a transmission unit, a reception unit, a control unit, and an antenna device, wherein
the terminal device is a radar device,
the antenna device includes:
one or a plurality of feeding antennas provided on a main surface of a substrate;
a parasitic antenna provided on the main surface of the substrate; and
a terminator provided on the substrate and connected to the parasitic antenna, and
the terminator includes an SIW that is a waveguide extending in the substrate.
